(19) United States
(12) Patent Application Publication
(10) Pub. No.: US 2007/0089231 A1
(43) Pub. Date: Apr. 26, 2007

(54) EMERGENCY EYEWASH STATION HAVING A PEIRCING MECHANISM TO PUNCTURE A SEALED FLUID BLADDER

(75) Inventors: Daniel P Smith, Portsmouth, RI (US); Benoit Devinat, Providence, RI (US); Michael C. Pereira, Smithfield, RI (US)

Correspondence Address: BARLOW, JOSEPHS & HOLMES, LTD., 101 DYER STREET, 5TH FLOOR, PROVIDENCE, RI, 02903, US

(73) Assignee: FENDALL, INC., Plattville, WI (US)

(21) Appl. No.: 11/551,928

(22) Filed: Oct. 23, 2006

Related U.S. Application Data
(60) Provisional application No. 60/729,513, filed on Oct. 24, 2005.

(51) Int. Cl. A61H 33/00; A61H 33/04

(52) U.S. Cl. 4/620

(57) ABSTRACT

An emergency eyewash station is disclosed. The eyewash station includes a body portion and a reservoir contained within the body portion. The reservoir contains eyewash fluid and has a filling port with a sealed membrane thereon. An actuator assembly is connected to the body portion and is movable between an armed position and an actuated position. The actuator assembly has a dispensing structure thereon. A piercing mechanism is positioned adjacent to the membrane of the reservoir and has a movable piercing element configured to puncture the membrane when the actuator assembly is activated. Activating the actuator assembly puts the dispensing structure in fluid connection with the reservoir when the piercing element pierces the membrane. In an alternative embodiment, the reservoir is configured to be impaled upon the piercing element upon activation.

### CROSS-REFERENCE TO RELATED APPLICATION

The present invention claims priority to earlier filed U.S. Provisional Patent Application 60/729,513, filed Oct. 24, 2005, the contents of which are incorporated herein by reference.

### BACKGROUND OF THE INVENTION

1. Field of the Invention

The present invention relates generally to emergency eyewash stations and more particularly to an emergency eyewash station having a piercing mechanism to puncture a sealed bladder having a “sterile” eyewash fluid contained therein.

2. Background of the Related Art

Government and employers are increasingly aware of the need for protecting the health and safety of workers. For this reason, it is common to find eye wash fountains at industrial work sites, laboratories, and other locations where workers are exposed to gaseous fumes, liquids or solid materials which can irritate or injure eyes upon contact therewith. The Occupational Safety and Health Administration (OSHA) has made eye wash fountains mandatory for particular industrial work stations.

Early installations of eye wash fountains employed sprays of regular tap water fed from regular plant plumbing connections. These devices were adequate for a period of time, but suffered from the drawbacks of using the regular water supply. For example, there could be contaminants and bacteria in regular plumbed water. Furthermore, the pressure of regular running water is inconsistent creating an uneven water flow, or in the event of a major facility accident, the water may not be running at all.

Later devices, such as the eye wash fountains disclosed in U.S. Pat. No. 4,012,798 to Liautaud and U.S. Pat. No. 4,363,146 to Liautaud, were self-contained, gravity-fed, and independent of any plumbing connections. These self-contained eye wash fountains typically included a reservoir (or bottles) of wash fluid spaced above two opposed liquid spray nozzles. Upon activating the fluid flow, the wash fluid from the reservoir is fed solely by gravity to the nozzles to cause a gravity-induced spray of wash fluid from the nozzles. These stations provided improved safety in terms of the quality of the water utilized but suffered from low and/or inconsistent water pressure to properly flush the eyes.

In an effort to encourage more suitable eye wash facilities, the American National Standards Institute (ANSI) promulgated voluntary standards for portable eye wash fountains relating to flushing periods and the rate of flow of wash fluid. These standards dictate that portable eye wash fountains should deliver no less than 0.4 gallons per minute (1.5 liters per minute) of eye wash fluid for a time period of 15 minutes. Responsive to the new ANSI standard, several designs emerged that included means for maintaining a constant eye wash flow rate without any powered pumping mechanisms. For example, U.S. Pat. No. 5,566,406, U.S. Pat. No. 5,695,124 and U.S. Pat. No. 5,850,641 all issued to Demeny et al, disclose an emergency eyewash station having a gravity assist mechanism that acts on a flexible reservoir contained in a disposable paperboard box. The self-contained emergency eye wash station generally comprises a housing, a reservoir, and a platen. The housing includes a shelf that supports a pair of flexible containers arranged in side-by-side relation. The flexible containers are of the type generally referred to as “bag-in-a-box” packaging, having an inner flexible plastic bag containing the eyewash fluid, and an outer cardboard box structure, which supports the flexible bag in a predetermined shape. The housing further supports a delivery platform including a nozzle, which is in fluid communication with the flexible container. The nozzle selectively dispenses the eye wash fluid from the flexible container when activated. The housing further includes a drain that captures the eye wash fluid dispensed from the nozzle and directs the eye wash fluid into the reservoir. The reservoir is slidably mounted to the housing and the platen is connected to the reservoir. As the reservoir fills, the platen presses downward on the flexible container with a downward force proportional to a weight of the eye wash fluid collected in the reservoir. The transfer of the weight of the eye wash fluid collected in the reservoir to the platen maintains a constant flow of eye wash fluid dispensed from the nozzle.

The above-noted gravity assist configuration has been very successful in the marketplace and is still in widespread use today. Because the 6 gallons of fluid is divided into two smaller containers, the flexible reservoirs are relatively small and easily replaced by service personnel. In addition, the bag-in-a-box packaging technology is well established, and the costs for producing, maintaining and replacing the disposable cartridges at established intervals of time have heretofore been relatively inexpensive. The costs for this type of system are such that the manufacturer could cost effectively provide a pre-assembled delivery tube and nozzle assembly with each of the disposable cartridges, making installation and replacement that much easier.

However, new ANSI and OSHA regulations have created new issues that will need to be addressed, and will require improvements to the existing designs to maintain compliance. In particular, upcoming OSHA regulations will soon require the use of “sterile” eye wash fluids. The regulatory and production requirements for “sterile” eyewash fluids are far greater than the previous “non-sterile” standards and will make the production of the existing cartridges cost prohibitive.

Accordingly, there is a need in the industry for an improved cartridge assembly which can be filled with a sterile fluid, maintained in a sterile condition for the required shelf-life of the product, provide for safe shipment, handling and storage of the product, and provide for simple installation and replacement, and finally provide a reliable dispensing arrangement for emergency use. Furthermore, there is a need for an improved delivery system which can accommodate the different requirements of the new “sterile” cartridge assemblies, while reducing costs and maintaining simple installation and upkeep of the system.

### SUMMARY OF THE INVENTION

The emergency eyewash station of the present invention addresses the problems of the prior art by uniquely providing an emergency eyewash station including an improved cartridge assembly having a sterile “bag” or bladder with a sealed filling port, and further including a dispensing nozzle having a piercing element to pierce the sealed filling port upon actuation of the unit.

The improved cartridge assembly of the present invention addresses the problems of the prior art by providing an improved “bag-in-a-box” cartridge assembly comprising a reusable, rigid plastic, outer housing and a disposable flexible inner bladder or bag containing a sterilized eyewash fluid therein.

The flexible bag comprises a flexible plastic material configured for optimal displacement and capacity within the housing. The flexible bag is filled using a proprietary filling system and filling port that maintains sterility of the inside of the bag and the fluid during the filling process. The filling port is sealed with a plastic membrane that can be pierced to release the fluid. The filling port includes a rigid plastic retaining collar having spaced flanges that are captured in an orifice formed between the mating halves of the housing. The filling port is thus captured in a fixed position for puncturing of the membrace and dispensing of the fluid when mounted in a corresponding dispensing unit, i.e. emergency eyewash station.

The main body portion of the eye wash station has a pivoting actuator arm assembly having a dispensing structure thereon for dispensing the eyewash fluid. The actuator arm assembly can be pivoted from an upright closed position to an activated prone position. Attached to the dispensing structure is an eyepiece for dispensing eyewash fluid, which has one end of a dispensing hose attached thereto. The opposite end of the dispensing hose is connected to a piercing mechanism having a piercing element slidably received therein. The piercing mechanism is positioned below the filling port of the cartridge assembly. As noted above, the filling port is retained in a fixed position for puncturing thereof. The eyepiece, hose and piercing mechanism are in fluid connection to each other. Upon activation of the eyewash station by pivoting the actuator arm assembly, the actuator arm assembly drives the piercing element of the piercing mechanism through the membrane on the filling portion, thereby rupturing the membrane and allowing the eyewash fluid to flow therefrom.

### BRIEF DESCRIPTION OF THE DRAWINGS

These and other features, aspects, and advantages of the present invention will become better understood with reference to the following description, appended claims, and accompanying drawings where:

FIG. 1 is a perspective view of the preferred embodiment of the present invention;

FIG. 2 is front view of the preferred embodiment of the present invention after activation;

FIG. 3 is a front view of the preferred embodiment of the present invention prior to activation;

FIG. 4 is a side view of the preferred embodiment of the present invention prior to activation;

FIG. 5 is a side cross-section view through line 3-3 of FIG. 3;

FIG. 6 is a side cross-section view through line 2-2 of FIG. 2;

FIG. 7 is an exploded perspective view of the cartridge assembly;

FIG. 8 is an enlarged cross-sectional view of the bladder and filing port thereof;

FIG. 9 is a bottom view of the preferred embodiment of the actuator arm of the present invention;

FIG. 10 is a side view of the preferred embodiment of the actuator arm engaging the piercing mechanism of the present invention;

FIG. 11 is a side view of the preferred embodiment of the piercing mechanism of the present invention after activation;

FIG. 12 is a side cross-section view of the piercing mechanism of the preferred embodiment shown in FIG. 11;

FIG. 13 is a side view of the preferred embodiment of the piercing mechanism of the present invention prior to activation;

FIG. 14 is a side cross-section view of the piercing mechanism of the preferred embodiment shown in FIG. 13; and

FIGS. 15 and 16 are perspective views of an alternative embodiment wherein the piercing mechanism is held stationary within the main body and actuation of the handle lowers the cartridge assembly downwardly onto the piercing mechanism to pierce the membrane.

### DESCRIPTION OF THE PREFERRED EMBODIMENT

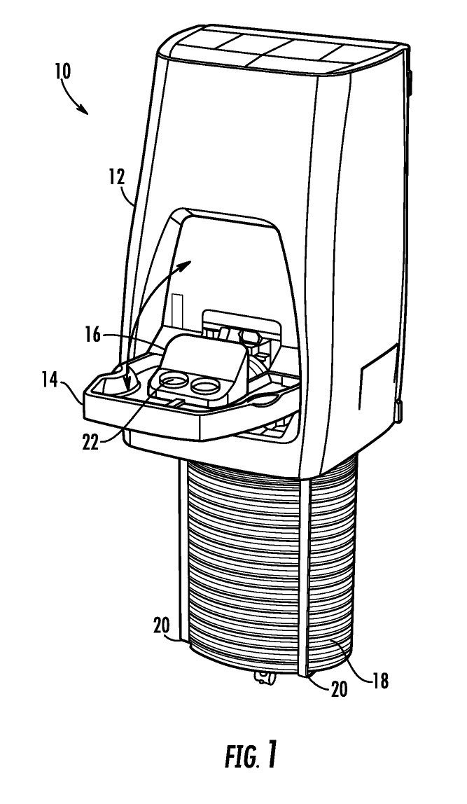

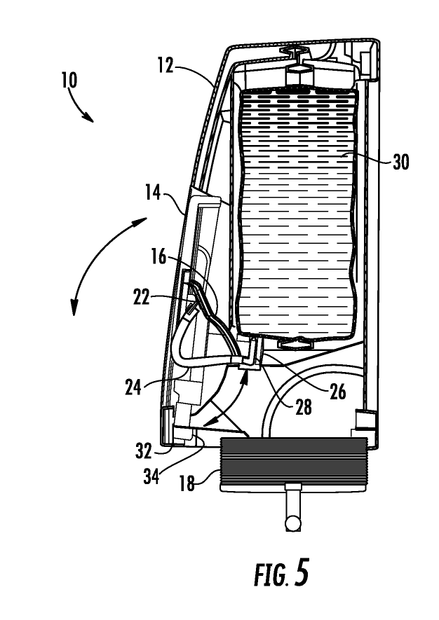

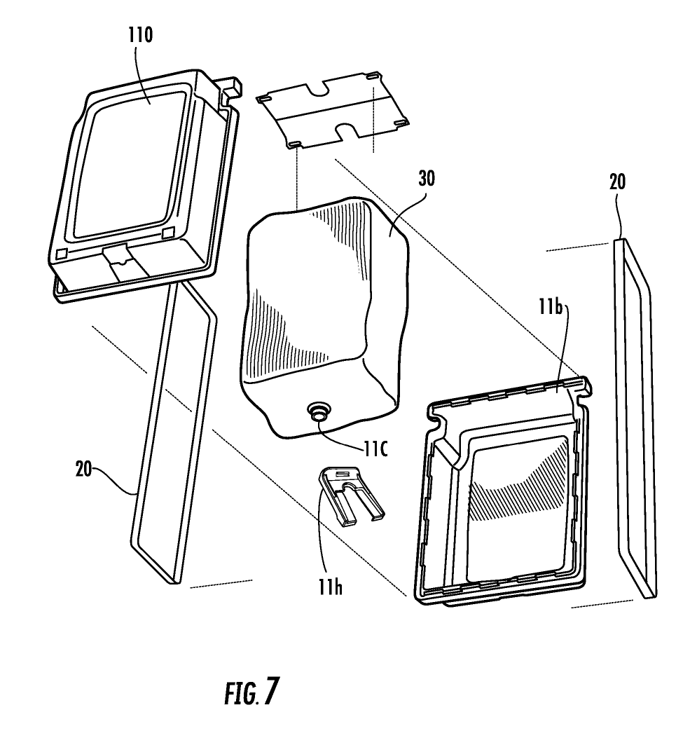

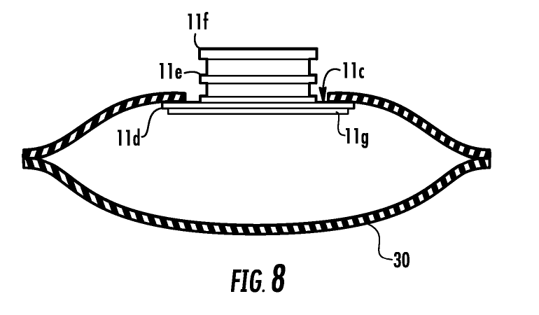

Referring to FIGS. 1-8, the emergency eyewash station of the present invention is shown generally at 10. As will be described in greater detail below, the emergency eyewash station 10 of the present invention includes an eyewash cartridge assembly 11 and a dispensing unit 12, which is operable for dispensing eyewash fluid from the cartridge assembly 11 upon activation of a pivoting actuator arm assembly 14.

The cartridge assembly 11 generally comprises a reusable, rigid plastic, outer housing and a disposable flexible inner bladder or bag 30 containing a sterilized eyewash fluid therein.

The housing is formed from two symmetrically identical housing sections 11a, 11b each having interfitting mating formations that permit the housing sections to be snap-fit together and maintained in assembled relation.

The flexible bag 30 comprises a flexible plastic material configured for optimal displacement and capacity within the housing. The flexible bag 30 is filled using a proprietary filling system and filling port 11c that maintains sterility of the inside of the bag and the fluid during the filling process. The filling port 11c includes a rigid plastic retaining collar 11d having spaced flanges 11e, 11f that are captured in an orifice formed between the mating halves 11a, 11b of the housing. The filling port is sealed on the inside by a membrane 11g. A retaining collar 11h cooperates with an edge of the one of the housing sections to form the orifice to capture the fill port in fixed position. The filling port 11c is thus captured in a fixed position for puncturing and dispensing of the fluid when mounted in the dispensing unit 12.

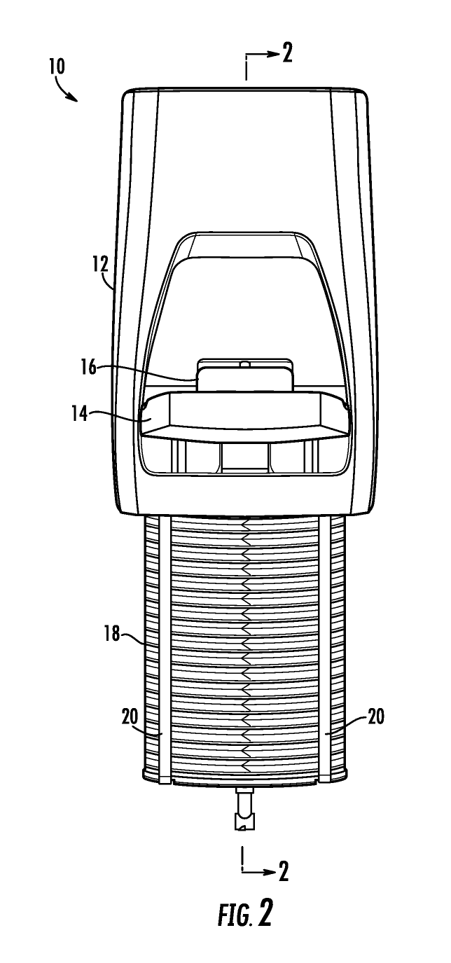

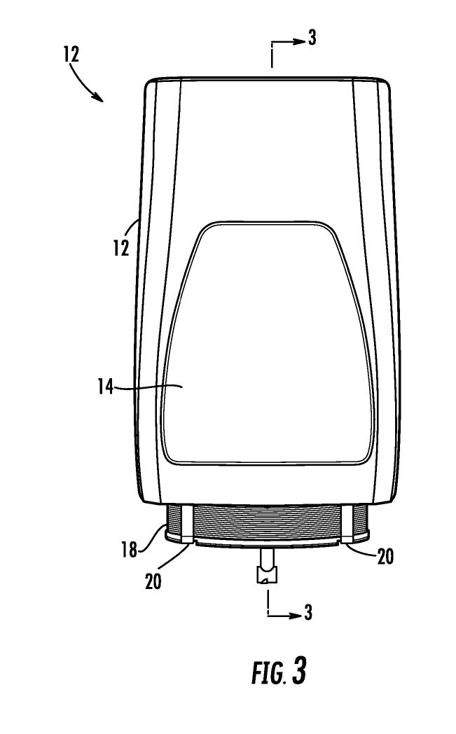

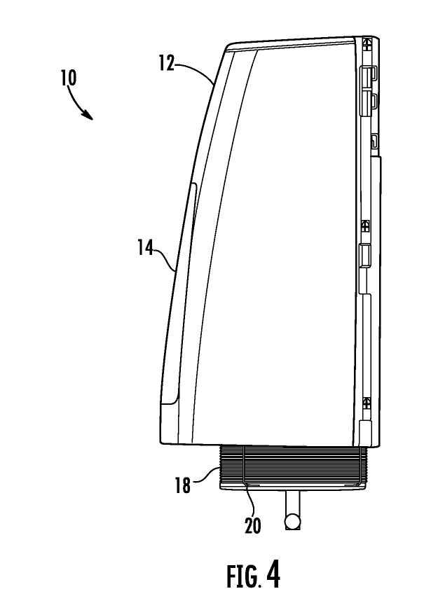

Referring back to FIGS. 2 and 3, the main dispensing unit 12 includes a pivoting actuator arm assembly 14 having a dispensing structure 16 thereon for dispensing the eyewash fluid. The actuator arm assembly 14 can be pivoted from an upright closed position to an activated prone position. When in the closed position, as shown in FIGS. 3 and 4, the actuator arm assembly 14 conforms to the main body portion 12 to present a uniform appearance and prevent accidental discharge of the eyewash station 10. Although it is preferred that the actuator arm assembly 14 pivot downwardly, one-skilled in the art would appreciate that the actuator arm assembly could be configured and arranged to slide or pivot in another direction as desired with equally effective results. Also included in the eyewash station 10 of the present invention is a waste collection reservoir system that includes an expandable bellows 18 with straps 20 to assist the gravity feed of the eyewash fluid.

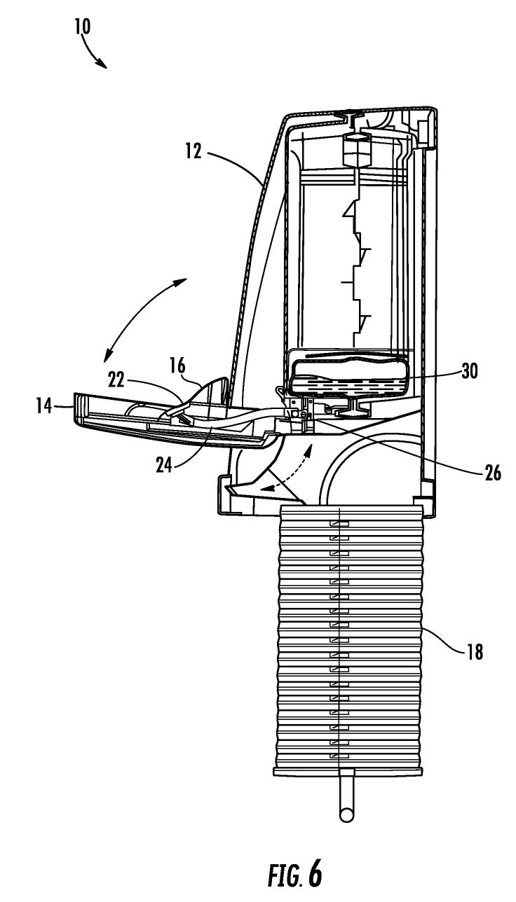

Referring to FIGS. 1, 5 and 6, attached to the dispensing structure 16 is an eyepiece 22 for dispensing eyewash fluid. The eyepiece 22 has one end of a dispensing hose 24 attached thereto. The opposite end of the dispensing hose 24 is connected to a piercing mechanism 26 having a piercing element 28 slidably received therein. The piercing mechanism 26 is positioned below the sealed bladder 30, which contains the eyewash fluid. The eyepiece 22, hose 24 and piercing mechanism 26 are in fluid connection to each other. Upon activation of the eyewash station 10 by pivoting the actuator arm assembly 14, as shown in FIG. 6, the actuator arm assembly 14 drives the piercing element 28 of the piercing mechanism 26 through the membrane 11g and into the bladder 30, thereby rupturing the bladder 30 and allowing the eyewash fluid to dispense therefrom.

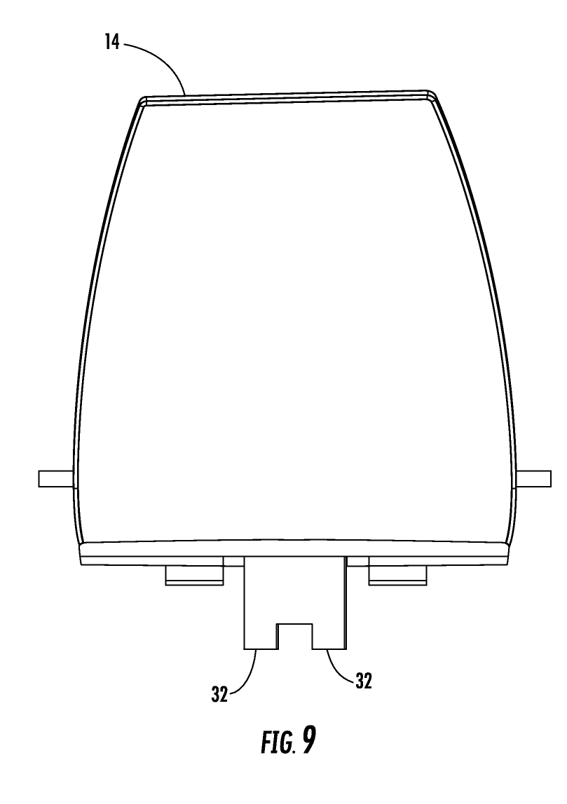

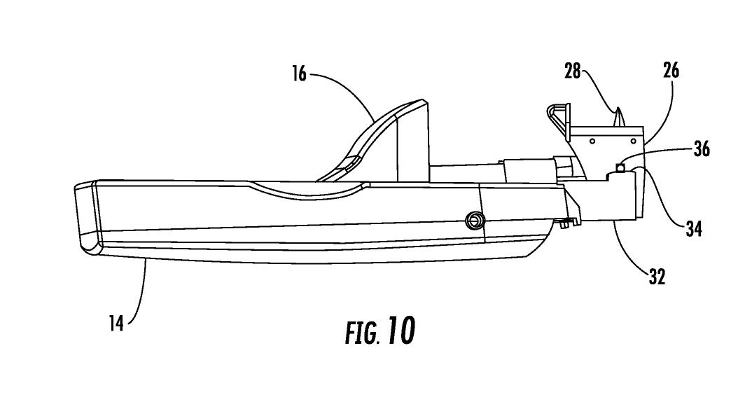

As best seen in FIG. 9, the actuator arm assembly 14 has a pair of depending fingers 32. Turning to FIG. 10, the depending fingers 32 each have a raised contact surface 34 thereon that engages tabs 36 (described in greater detail below) on the piercing element 28 of the piercing mechanism 26.

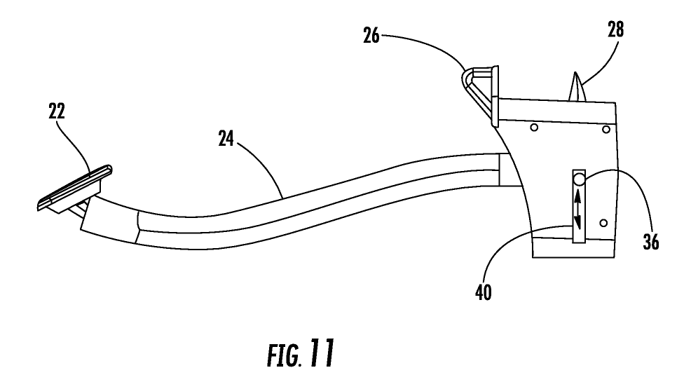

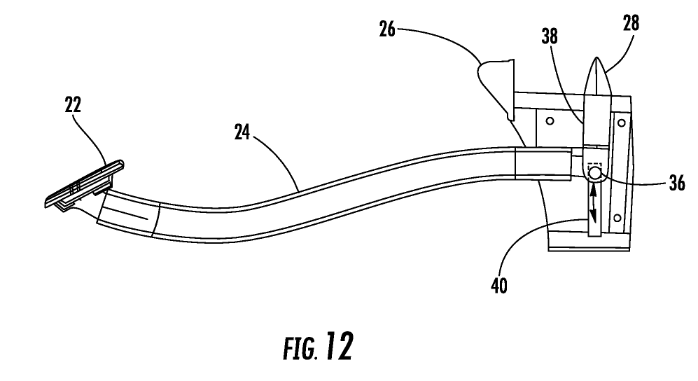

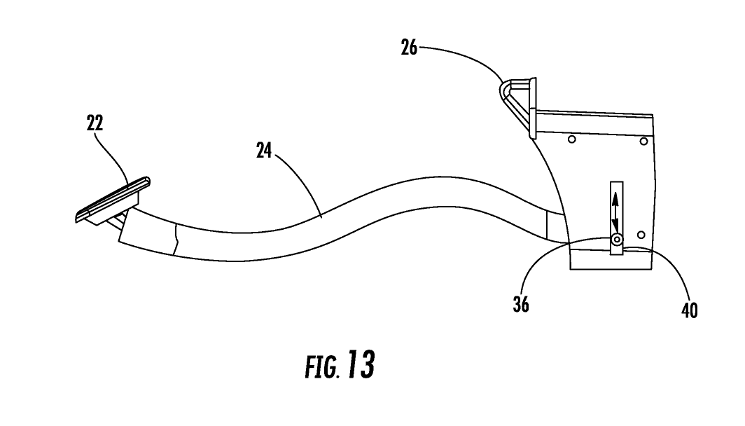

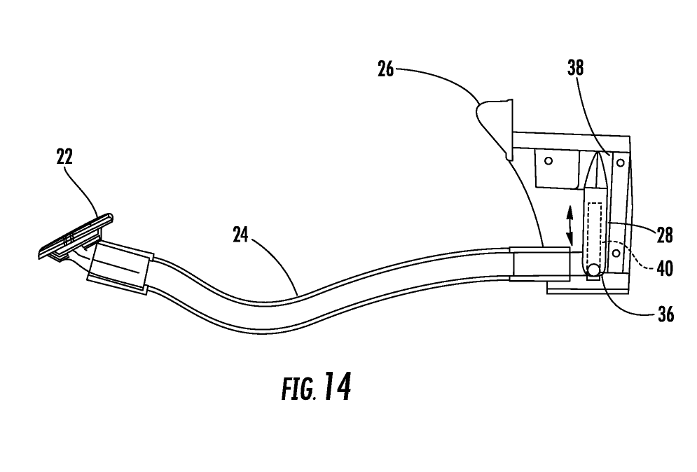

Shown in isolation in FIGS. 11-14, the piercing mechanism 26 with hose 24 and eyepiece 22 attached thereto are shown in greater detail. In particular, the piercing mechanism has a body having a chamber 38 and a pair of opposing slots 40. The piercing element 28 is fit within the chamber 39 of the mechanism body and can slide upwardly and downwardly as shown in FIGS. 10 and 12. The piercing element 28 also has a pair of tabs 36 extending laterally from the piercing element 28 that engage the slots 40 on the mechanism body. The tabs limit that upward and downward travel of the piercing element 28, as shown in FIGS. 9 and 12. Although it is a preferred embodiment that the piercing element 28 is slidably mounted within the piecing mechanism, it could also be pivotally mounted.

Therefore, it can be seen that the present invention provides a unique solution to the problems of the prior art by providing an emergency eyewash station that uniquely includes a piercing mechanism to rupture a bladder containing eyewash fluid.

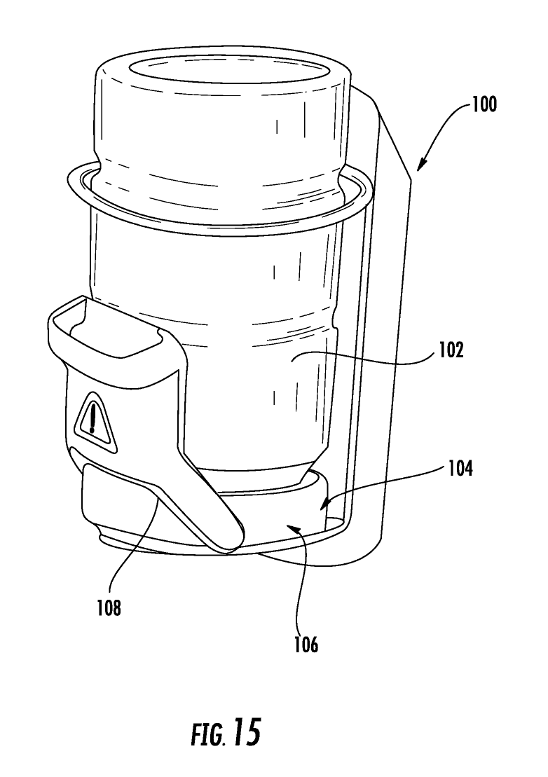

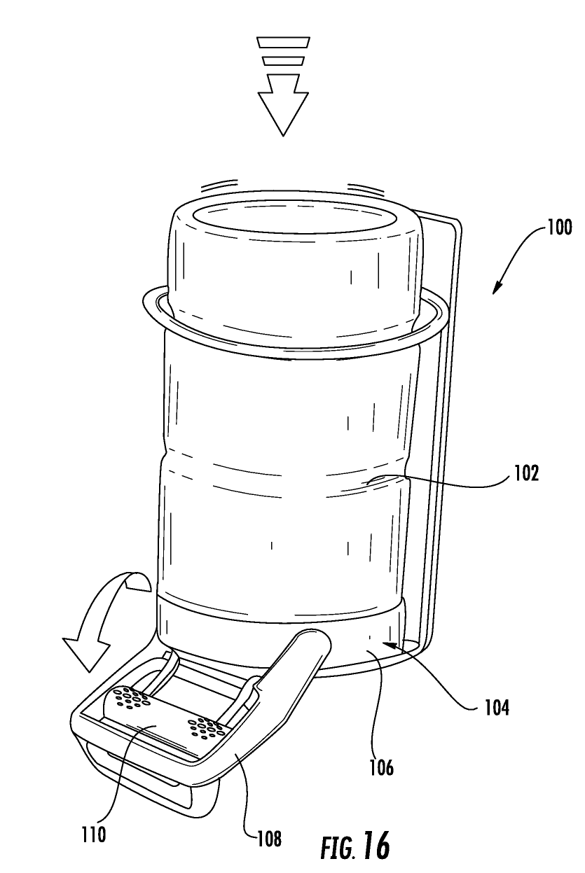

Referring to FIGS. 15 and 16, an alternative embodiment of the present invention is illustrated and generally indicated at 100. The unit 100 would generally comprise a cartridge assembly 102 containing sterile eyewash fluid and the main dispensing unit 104.

The cartridge assembly 102 can comprise a structure somewhat identical to the cartridge 11 of the earlier embodiment or may comprise a bottle structure as illustrated. In either case, the cartridge 102 includes a filling port having a membrane 11h (not shown in the present embodiment) that seals the eyewash fluid within the cartridge.

The main dispensing unit 104 includes a platform 106 for supporting the cartridge 102 and a pivoting actuator arm 108. The platform 106 in turn includes a stationary piercing element (not shown) which is positioned immediately below the neck of the bottle and directly in alignment with the sealing membrane 11h.

The pivoting actuator arm 108 includes a dispensing structure 110 thereon for dispensing the eyewash fluid. The actuator arm 108 can be pivoted from an upright closed position (FIG. 15) to an activated prone position (FIG. 16). When in the upright closed position, the actuator arm maintains the cartridge in a raised position above the piercing element. When the actuator arm 108 is moved to the activated prone position, the cartridge 102 is released and the cartridge 102 is essentially impaled on the piercing element to pierce the membrane and dispense the eyewash fluid. The piercing element and the dispensing structure are connected in fluid communication by a hose in a conventional manner.

It would be appreciated by those skilled in the art that various changes and modifications can be made to the illustrated embodiments without departing from the spirit of the present invention. All such modifications and changes are intended to be within the scope of the present invention except as limited by the appended claims.

What is claimed is:

1. An emergency eyewash station, comprising:
a body portion;
a reservoir disposed within said body portion, said reservoir containing eyewash fluid therein and having a filling port with a sealed membrane thereon;
a dispensing mechanism having a movable piercing element positioned adjacent to said membrane of said reservoir and being configured and arranged to puncture said sealed membrane, said dispensing mechanism further having a dispensing structure in fluid communication with said piercing element; and
an actuator assembly coupled to said piercing element, said actuator assembly being movable between an armed position wherein said piercing element is positioned adjacent said membrane, and an actuated position wherein said piercing element is pierced through said membrane,
said eyewash fluid being dispensed from said reservoir to said dispensing structure when said actuator assembly is moved from said armed position to said actuated position and said piercing element pierces said membrane on said reservoir.

2. The eyewash station of claim 1, wherein said actuator assembly is pivotally movable between said armed position and said actuated position.

3. The eyewash station of claim 1, wherein said reservoir is a flexible bladder.

4. The eyewash station of claim 3, further comprising:
a bracket for capturing said filling port in a fixed position relative to said movable piercing element.

5. The eyewash station of claim 1, further comprising:
means for collecting waste eyewash fluid.

6. The eyewash station of claim 5, where said means for collecting waste eyewash fluid is an expandable bellows.

7. The eyewash station of claim 3, further comprising:
means for collecting waste eyewash fluid.

8. The eyewash station of claim 7, where said means for collecting waste eyewash fluid is an expandable bellows.

9. The eyewash station of claim 8, further comprising:
means for compressing said flexible bladder.

10. The eyewash station of claim 9, wherein said means for compressing said flexible bladder comprises:
at least one strap connected between said flexible bladder and said reservoir.

11. An emergency eyewash station, comprising:
a body portion;
a flexible reservoir disposed within said body portion, said reservoir containing eyewash fluid therein and having a filling port with a sealed membrane thereon;
a dispensing mechanism having a slidable piercing mechanism positioned adjacent to said membrane of said flexible reservoir and being configured and arranged to puncture said sealed membrane, said dispensing mechanism further having a dispensing structure in fluid communication with said piercing element, said slidable piercing element having a pair of laterally projecting engagement tabs;
an actuator assembly coupled to said piercing element, said actuator assembly being pivotably movable between an armed position wherein said piercing element is positioned adjacent said membrane, and an actuated position wherein said piercing element is pierced through said membrane,
said actuator assembly having a pair of depending fingers with raised contact surfaces thereon, said raised contact surfaces being configured and arranged to engage said engagement tabs on said piercing element and to drive said piercing element through said membrane when said actuator arm is pivoted from said armed position to said actuated position,
said eyewash fluid being dispensed from said reservoir to said dispensing structure when said actuator assembly is moved from said armed position to said actuated position and said piercing element pierces said membrane on said reservoir.

12. The eyewash station of claim 11, further comprising:
a bracket for capturing said filling port in a fixed position relative to said movable piercing element.

13. The eyewash station of claim 11, further comprising:
means for collecting waste eyewash fluid.

14. The eyewash station of claim 11, where said means for collecting waste eyewash fluid is an expandable bellows.

15. An emergency eyewash station, comprising:
a body portion;
a movable reservoir disposed within said body portion, said reservoir containing eyewash fluid therein and having a filling port with a sealed membrane thereon;
a dispensing mechanism having a stationary, upwardly projecting piercing element positioned adjacent to said membrane of said movable reservoir and being configured and arranged to puncture said sealed membrane, said dispensing mechanism further having a dispensing structure in fluid communication with said piercing element; and
an actuator assembly coupled to said movable reservoir, said actuator assembly being movable between and armed position wherein said sealed membrane is positioned above said stationary piercing element, and an actuated position wherein said membrane of said reservoir is impaled on said piercing element,
said eyewash fluid being dispensed from said reservoir to said dispensing structure when said actuator assembly is moved from said armed position to said actuated position and said piercing element pierces said membrane on said reservoir.

16. The eyewash station of claim 15, wherein said actuator assembly is pivotally moved between said armed position and said actuated position.
